(19) United States
(12) Patent Application Publication
(10) Pub. No.: US 2013/0092796 A1
(43) Pub. Date: Apr. 18, 2013

(54) SPEED LIMITING APPARATUS AND METHOD

(71) Applicant: John T. Weinel, Lakeville, MN (US)

(72) Inventor: John T. Weinel, Lakeville, MN (US)

(21) Appl. No.: 13/637,219

(22) PCT Filed: Mar. 25, 2010
(86) PCT No.: PCT/US10/28707

§ 371 Date: Dec. 18, 2012

(51) Int. Cl. B64D 17/72

(52) U.S. Cl. CPC B64D 17/72
USPC 244/149

(57) ABSTRACT

In various examples, a speed limiting apparatus (100, 200) includes a garment (102, 202)) configured to be worn by a user (10). The garment includes an enclosure (110, 220). A speed limiting assembly (120, 220) is coupled to the garment. The speed limiting assembly includes a chute (136, 236) disposed within the enclosure with the chute in a storage configuration (120A). The chute is deployable from the storage configuration to a deployed configuration (120B). A deployment bladder (130, 230) is separate from the chute. The deployment bladder is positioned proximate the enclosure and the chute such that at least partial inflation of the deployment bladder opens the enclosure and deploys the chute. In another example, a method of using a speed limiting apparatus is provided.

### TECHNICAL FIELD

This patent document pertains generally to a speed limiting apparatus and method. More particularly, but not by way of limitation, this patent document pertains to an apparatus and method for limiting, decreasing, or otherwise retarding the speed of a user, such as a skier, snowboarder, snowmobiler, climber, hiker, or the like.

### BACKGROUND

It is dangerous for skiers, snowboarders, and snowmobilers (referred to generally as “skiers”), in particular in more extreme downhill conditions, to enter an undesirable area of a mountain, such as a steep slope, a rocky or tree covered area, or a cliff. In some instances, skiers lose control, fall, and are unable to stop themselves from entering such an undesirable area. In other instances, skiers inadvertently ski into such areas if lost, disoriented, or otherwise confused. The result of such a mistake may result in serious injury or death to the skier.

### BRIEF DESCRIPTION OF THE DRAWINGS

In the drawings, like numerals describe similar components throughout the several views. Like numerals having different letter suffixes represent different instances of similar components. The drawings illustrate generally, by way of example, but not by way of limitation, various embodiments discussed in the present document.

FIG. 1 is a front view of a speed limiting apparatus in accordance with an example of the present invention, the apparatus being in an undeployed configuration;

FIG. 2 is a rear view of the speed limiting apparatus of FIG. 1;

FIG. 3 is a side view of the speed limiting apparatus of FIG. 1;

FIG. 4 is a side view of the speed limiting apparatus of FIG. 1, the apparatus being in a deployed configuration;

FIG. 5 is a rear view of the speed limiting apparatus of FIG. 1 showing components of an activation mechanism of the speed limiting apparatus of FIG. 1;

FIG. 6 illustrates the speed limiting apparatus of FIG. 1 in a deployed configuration in use during a fall; and

FIG. 7 is a side view of a speed limiting apparatus in accordance with an example of the present invention, the apparatus being in a deployed configuration.

### DESCRIPTION OF THE EMBODIMENTS

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that structural changes may be made without departing from the scope of the present invention. Therefore, the following detailed description is not to be taken in a limiting sense, and the scope of the present invention is defined by the appended claims and their equivalents.

The present inventor has recognized, among other things, that loss of control and/or falling while downhill skiing, snowboarding, snowmobiling, or the like can result in injury or death to the person performing the activity. The present inventor has further recognized that there exists an unmet need for a speed limiting device that can be used in the event that the skier, snowboarder, snowmobiler, etc. loses control and/or falls in order to selectively decrease, limit, retard, etc. the speed with which the individual is traveling and/or falling.

This patent document describes, among other things, apparatuses for limiting the speed of a user, for instance, a skier, snowboarder, snowmobiler, or the like. In various examples, the speed limiting apparatuses include a chute and a deployment bladder separate from the chute and configured to deploy the chute.

In Example 1, a speed limiting apparatus includes a garment configured to be worn by a user. The garment includes an enclosure. A speed limiting assembly is coupled to the garment. The speed limiting assembly includes a chute disposed within the enclosure with the chute in a storage configuration. The chute is deployable from the storage configuration to a deployed configuration. A deployment bladder is separate from the chute. The deployment bladder is positioned proximate the enclosure and the chute such that at least partial inflation of the deployment bladder opens the enclosure and deploys the chute.

In Example 2, the speed limiting apparatus of Example 1 optionally is configured such that the deployment bladder is disposed at least partially within the enclosure. In Example 3, the speed limiting apparatus of one or more of Examples 1-2 optionally is configured such that the chute is attached to the deployment bladder.

In Example 4, the speed limiting apparatus of one or more of Examples 1-3 optionally includes an inflation mechanism configured to at least partially inflate the deployment bladder.

In Example 5, the speed limiting apparatus of Example 4 optionally is configured such that the inflation mechanism includes a gas canister and an activation mechanism. The gas canister is fluidly coupled to the deployment bladder and the activation mechanism coupled to the gas canister. In Example 6, the speed limiting apparatus of Example 5 optionally is configured such that the activation mechanism includes a rip cord.

In Example 7, the speed limiting apparatus of one or more of Examples 1-6 optionally is configured such that the chute includes a substantially circular shape. In Example 8, the speed limiting apparatus of one or more of Examples 1-7 optionally is configured such that the garment includes a vest.

In Example 9, the speed limiting apparatus of one or more of Examples 1-8 optionally is configured such that the garment includes a harness.

In Example 10, the speed limiting apparatus of one or more of Examples 1-9 optionally is configured such that the garment includes a belt.

In Example 11, the speed limiting apparatus of one or more of Examples 1-10 optionally is configured such that the chute is configured to increase air resistance of the user when in the deployed configuration to limit the speed of the user.

In Example 12, the speed limiting apparatus of one or more of Examples 1-11 optionally is configured such that the chute is configured to selectively detach from the speed limiting apparatus.

In Example 13, a method of use includes using a speed limiting assembly. The speed limiting assembly is coupled to a garment configured to be worn by a user. The method includes at least partially inflating a deployment bladder of the speed limiting assembly. An enclosure of the garment is opened. A chute of the speed limiting assembly is deployed from a storage configuration within the enclosure to a deployed configuration. The chute is configured to increase air resistance of the user when in the deployed configuration to limit the speed of the user. The chute is separate from the deployment bladder. At least partially inflating the deployment bladder opens the enclosure and removes the chute from within the enclosure to deploy the chute.

In Example 14, the method of Example 13 optionally is configured such that at least partially inflating the deployment bladder includes activating an actuation device.

In Example 15, the method of Example 14 optionally is configured such that activating the actuation device fluidly couples a gas canister with the deployment bladder to allow gas from the gas canister to flow into and at least partially inflate the deployment bladder.

In Example 16, the method of Example 15 optionally is configured such that activating the actuation device includes pulling a rip cord.

In Example 17, the method of one or more of Examples 13-16 optionally includes detaching the chute from the speed limiting assembly after deployment of the chute.

In Example 18, a speed limiting apparatus includes a garment configured to be worn by a user. The garment includes an enclosure. A speed limiting assembly is coupled to the garment. The speed limiting assembly includes an inflation mechanism. A chute is disposed within the enclosure with the chute in a storage configuration. The chute is deployable from the storage configuration to a deployed configuration. A deployment bladder is coupled to and at least partially inflatable by the inflation mechanism. The deployment bladder is disposed within the enclosure. The deployment bladder is separate from but attached to the chute. At least partial inflation of the deployment bladder opens the enclosure and deploys the chute. The chute, when in the deployed configuration, is configured to increase air resistance of the user to limit the speed of the user.

In Example 19, the speed limiting apparatus of Example 18 optionally is configured such that the inflation mechanism includes a gas canister and an activation mechanism. The gas canister is fluidly coupled to the deployment bladder, and the activation mechanism is coupled to the gas canister.

In Example 20, the speed limiting apparatus of one or more of Examples 18-19 optionally is configured such that the deployment bladder, when at least partially inflated, is positioned proximate a head of the user to provide at least some protection of the head of the user.

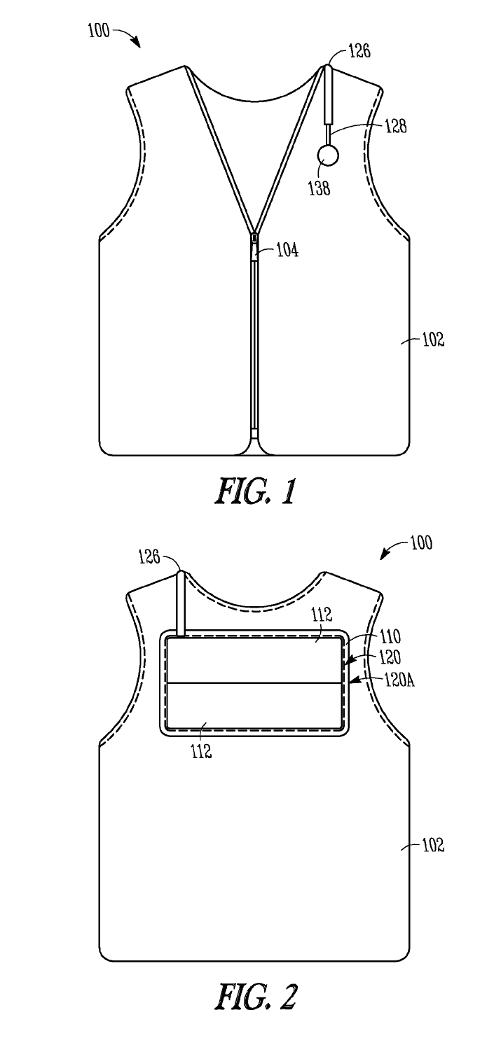

Referring to FIGS. 1-6, an example of a speed limiting apparatus 100 includes a garment 102 configured to be worn by a user 10 and a speed limiting assembly 120 coupled to the garment 102. The garment 102, in an example, can include a vest. In other examples, the garment 102 can take other forms, such as, but not limited to, a harness, a backpack, a belt, or any other garment capable of attaching the speed limiting apparatus 100 to a body of the user 10. In some examples, the garment 102 can include various fastening features 104 to retain the garment 102 on the user. In one example, the garment 102 includes a zipper. In another example, the garment 102 includes one or more belts and corresponding buckles. In still another example, the garment 102 includes one or more mating pairs of snap-fitting buckles. In still further examples, the garment 102 includes other fastening features including, but not limited to, hook and loop fasteners, laces (e.g., for knotting and/or tying), or the like. In still further examples, the garment 102 includes various combinations of fastening features.

In an example, the garment 102 includes an enclosure 110 configured to at least partially house the speed limiting assembly 120 in a storage configuration 120A. In some examples, the enclosure 110 includes an opening configured to allow at least some components of the speed limiting assembly 120 to deploy from within the enclosure 110. In an example, the enclosure 110 includes one or more flaps 112 configured to open with deployment of the speed limiting assembly 120. The one or more flaps 112 or, otherwise, an area of the enclosure 110 defining the opening can include one or more closure features to selectively maintain closure of the enclosure 110 to retain at least some of the components of the speed limiting assembly 120 within the enclosure 110 until deployment of the speed limiting assembly 120. Examples of the closure features include one or more mating Velcro® strips, one or more snaps, rip-stitching along one or more seams, or the like. The one or more closure features, in various examples, are configured to give way or otherwise open upon deployment of the speed limiting assembly 120, as will be described in greater detail below.

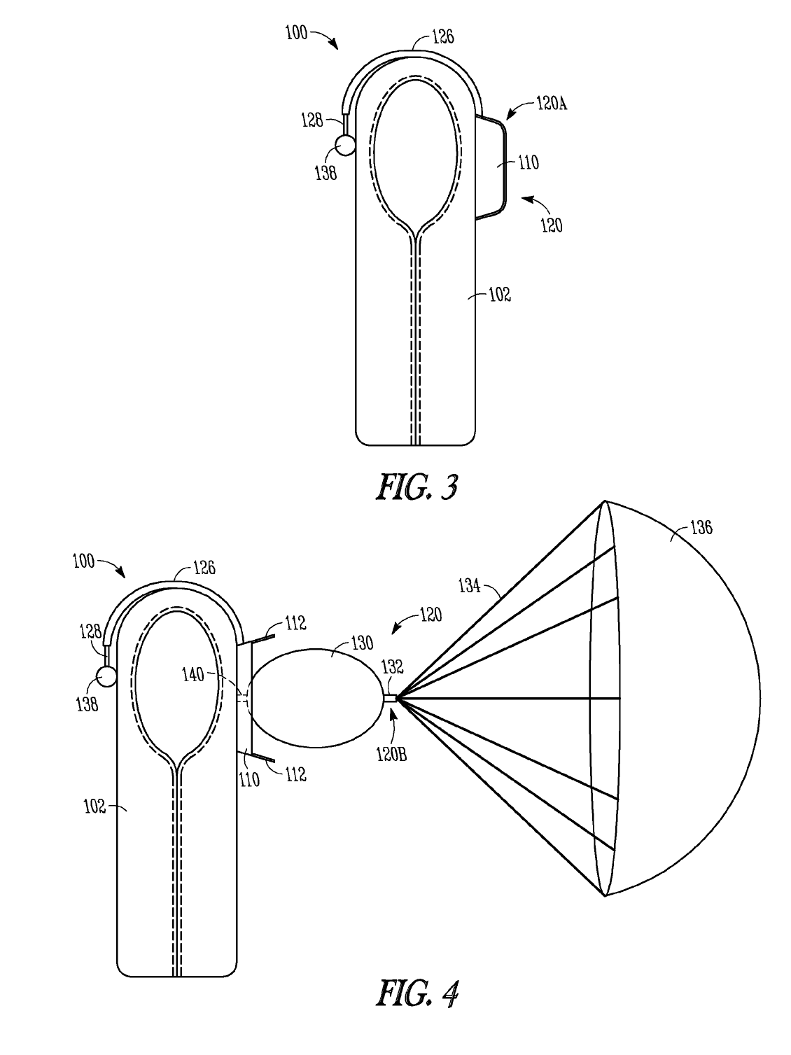

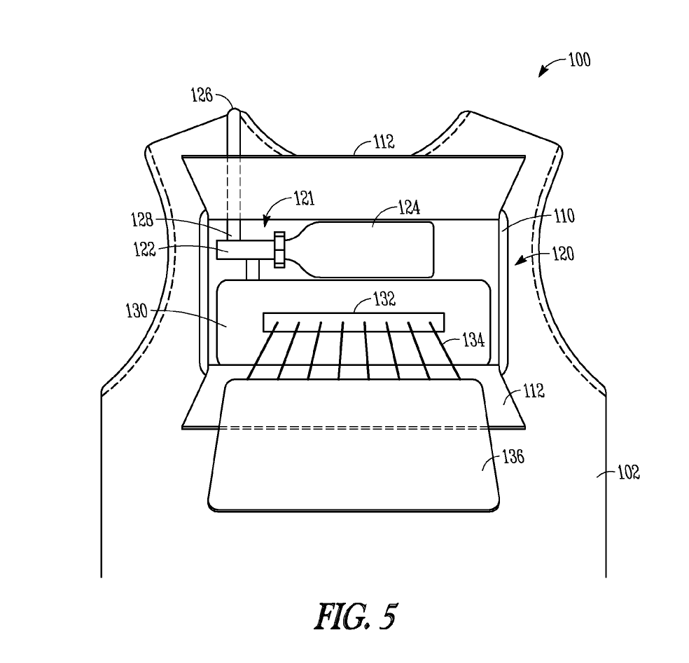

In an example, the speed limiting assembly 120 includes a chute 136 and a deployment bladder 130 separate from the chute 136. That is, in the example shown in FIG. 4, although the chute 136 is attached to the deployment bladder 130, the chute 136 is physically separate from the deployment bladder 130. In an example, the chute 136 is disposed within the enclosure 110 with the chute 136 in a storage configuration. In a further example, the chute 136 is deployable from the storage configuration (see FIG. 3 showing the speed limiting assembly 120 in the storage configuration 120A) to a deployed configuration (see FIG. 4 showing the speed limiting assembly 120 in the deployed configuration 120B).

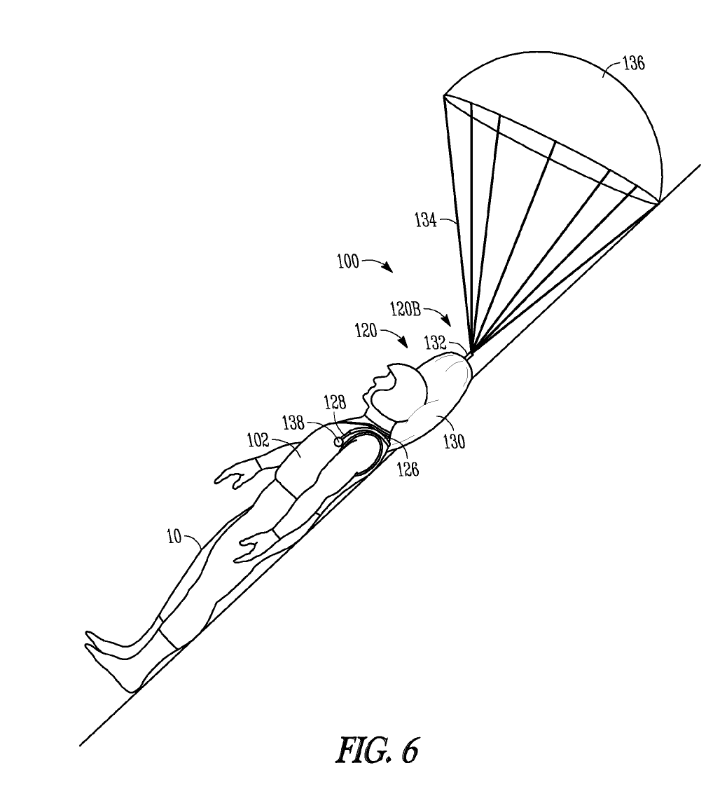

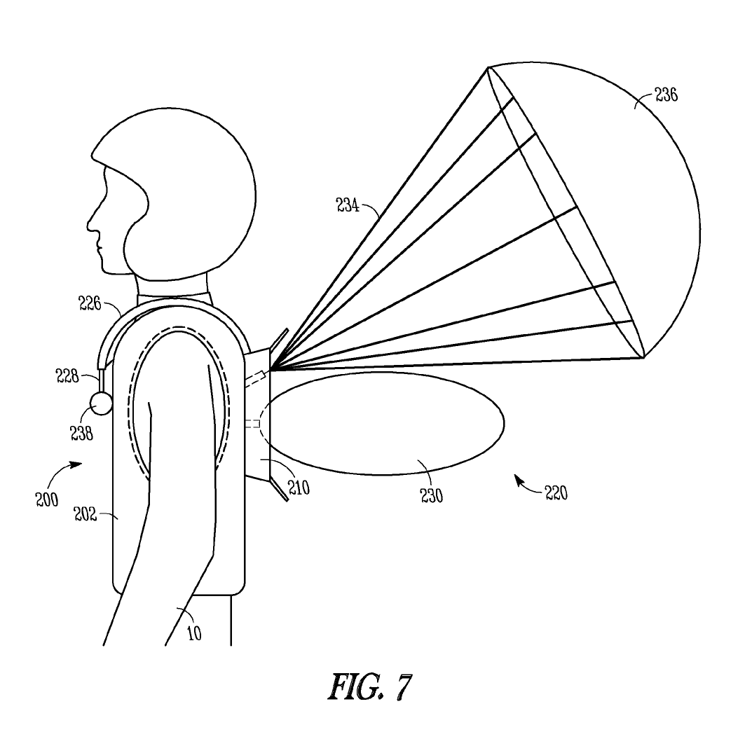

The deployment bladder 130, in an example, is positioned proximate the enclosure 110 and proximate the chute 136 with the speed limiting assembly 120 in the storage configuration 120A. In another example, the deployment bladder 130 is positioned at least partially within the enclosure 110. In still another example, the deployment bladder 130 is positioned within the enclosure 110 and proximate the chute 136 with the speed limiting assembly 120 in the storage configuration 120A. The deployment bladder 130, in an example, is configured to be inflated. FIGS. 4 and 6 show examples of an deployment bladder 130 in an inflated configuration. The deployment bladder 130 is constructed with or includes, for example, a polymer suitable for use in water or snow and is substantially gas impermeable. In another example, the deployment bladder 130 includes polyethylene, polypropylene, polyester, polyurethane, polyvinyl chloride or the like. In yet another example, a suitable polymer is combined with fibrous polymers such as nylon or aramid fiber to form the deployment bladder 130.

In an example, the deployment bladder 130, when inflated, is sized to be larger than the confines of the enclosure 110, such that, when at least partially inflated, the deployment bladder 130 applies force to an interior of the enclosure 110 and the one or more closure features to force the one or more closure features to give way or otherwise open, thereby opening the enclosure 110 and allowing the deployment bladder 130 to extend from the enclosure 110. In an example, when the speed limiting assembly 120 is in the storage configuration 120A, the deployment bladder 130 is positioned relative the chute 136, such that at least partial inflation of the deployment bladder 130 forces the chute 136 from within the enclosure 110 to aid in deployment of the chute 136.

In another example, the deployment bladder 130 is configured to pull open the enclosure 110. For instance, the deployment bladder can be attached to a flap of the enclosure such that inflation of the deployment bladder pulls on the flap and opens the enclosure for deployment of the chute.

In some examples, the chute 136 can include various shapes. In an example, the chute 136 includes a substantially circular shape. In another example, the chute 136 includes an ovular, elliptical, or another rounded shape.

In one example, the chute 136 is approximately six feet in diameter, although it is contemplated that the chute 136 is sized differently, provided the size of the chute 136 is sufficient to provide adequate air resistance/braking to limit the speed of the user 10 when it is desirable to do so. Having a chute 136 with a rounded shape like circular, elliptical, ovular, or the like lessens the likelihood that the chute 136 catches on or digs into the ground or becomes ensnared on rocks or other ground features, etc, due, in part, to the rounded shape of the chute 136 lacking corners. However, in other examples, chutes including various other shapes, including, but not limited to triangular, square, rectangular, hexagonal, or other polygonal shapes are contemplated. Regardless of the shape and size of the chute 136, in some examples, the chute 136 is configured to increase air resistance of the user 10 when the chute 136 is in the deployed configuration (FIGS. 4 and 6) to limit the speed of the user 10, for instance, if the user 10 falls on a steep or otherwise dangerous slope on which it would be difficult, if not impossible, to otherwise slow one's descent. As such, in various examples, the speed limiting apparatus 100 can be used to slow one's speed, with the chute 136 being configured to create drag and air resistance in order to help slow the user 10 and, ultimately, increase the chances of the user 10 stopping relatively safely and surviving a fall on a slope, for instance a steep slope, a slope having rocks, trees, or other obstacles, a slope having one or more drops, etc.

In another example, the deployment bladder 130, the chute 136, and/or the garment 102 has enhanced visibility, such as a bright color, to alert rescue personnel of the location of the user 10 and provide at least visual notification of the approximate location of the user 10.

In an example, the deployment bladder 130 is attached to the chute 136 at a connection strip 132. In this example, the chute 136 includes attachment cords 134 attaching the chute 136 to the connection strip 132. The number of attachment cords 134 can vary in different examples provided the number of attachment cords 134 are sufficient to maintain the chute 136 attached to the connection strip 132 during use. Also, although shown connected to the chute 136 around an outer edge of the chute 136, in other examples, the attachment cords 134 can be attached to the chute 136 at any point on the chute 136, provided they are arranged in a manner that allows the chute 136 to open and maintain itself in an open deployed configuration. In another example, the chute 136 can include a main attachment cord from the connection strip 132 that then branches into two or more attachment cords that then attach to the chute 136.

In an example, the attachment cords 134 are approximately two to three feet in length or are otherwise configured to extend the chute 136 approximately two to three feet from the deployment bladder 130. In an example, the deployment bladder 130, when deployed, extends approximately three feet from the garment 102, such that the chute 136, when deployed, extends approximately five to six feet from the garment 102. In an example, such placement of the chute 136, with respect to the user 10, extends the chute 136 far enough from the user 10 to reduce the effects of the user 10 obstructing air flow to the chute 136, which could adversely affect speed reduction and/or opening of the chute 136. Also, in an example, extending the cords 134 from the deployment chute 130 reduces the chances of the user 10 becoming entangled in the cords 134, thereby reducing the likelihood of the user 10 impairing the performance of the chute 136 or becoming injured by the cords 134 or the chute 136 during use. In other examples, the length of the cords and/or the length of the deployed deployment bladder 130 can be varied, provided the speed limiting apparatus 100 is capable of functioning to limit the speed of the user 10 when deployed.

In an example, the chute 136 can be configured to selectively detach from the speed limiting apparatus 100. For instance, the connection strip 132 can include a quick release mechanism or the like which can be actuated with a pull cord to disconnect the chute 136 from the deployment bladder 130. Such an arrangement could enable a user 10 who deployed the speed limiting assembly 120 to remove the chute 136 at a point when the user's descent down a slope has slowed sufficiently or the user 10 otherwise determines that the chute 136 is no longer needed in a deployed configuration. The user 10 can remove the chute 136, in this example, and then continue wearing the garment 102 without movements or actions of the user 10 being hampered by the chute 136, for instance, if the user 10 is able to ski, snowboard, snowmobile, hike, or otherwise move after the chute 136 is no longer needed in a deployed configuration.

In an example, the deployment bladder 130 is attached to the garment 102 along a harness strip 140. The harness strip 140 can be attached to the garment 102 within the enclosure 110, in an example. In another example, the harness strip 140 can be attached to the garment 102 in an area outside of the enclosure 110.

Referring to FIG. 5, in an example, the speed limiting apparatus 100 includes an inflation mechanism 121 configured to at least partially inflate the deployment bladder 130. The speed limiting apparatus 100 in FIG. 5 is shown with the enclosure 110 open and the chute 136 (in a folded storage configuration) partially pulled out to expose features of the inflation mechanism 121 and the speed limiting assembly 120 which would otherwise be hidden from view by the enclosure 110 and/or the chute 136. In an example, at least some of the components of the speed limiting assembly 120, including the inflation mechanism 121, are sized, shaped, and/or otherwise configured to fit within, or partially within, the enclosure 110 during storage. In this way, the speed limiting assembly 120 can be placed in the storage configuration 120A (FIGS. 2 and 3) and retained in a relatively compact manner with respect to the garment 102 so that the user 10 can wear the speed limiting apparatus 100 during skiing, snowboarding, snowmobiling, hiking, climbing, or any other activity in which the speed limiting apparatus 100 could be useful, with little additional weight, discomfort, obstruction of movement, or the like.

In an example, the inflation mechanism 121 includes at least one gas canister 124 and at least one activation mechanism 122. In an example, the activation mechanism 122 is coupled to the gas canister 124. The gas canister 124, in an example, is fluidly coupled to the deployment bladder 130. In an example, the activation mechanism 122 includes features such as a needle, valve, or the like adapted to open the gas canister 124 when desired to deploy the speed limiting assembly 120. The gas canister 124, in an example, is coupled to the activation mechanism 122, for example, by screwing the gas canister 124 into a threaded receptacle of the activation mechanism 122. In another example, the gas canister 124 is coupled to the activation mechanism 122 by welding, an interference fit, or the like. In this example, the activation mechanism 122 is coupled to the deployment bladder 130 to facilitate the flow of gas from the gas canister 124 to the deployment bladder 130.

In some examples, the deployment bladder 130 is stored in the enclosure 110 and is inflated by pulling on or otherwise actuating a trigger, such as a rip cord 128. The rip cord 128 is coupled with the gas canister 124 that contains a compressed gas (for instance, carbon dioxide, air, and/or the like). In an example, the rip cord 128 includes a gripping member 138 at an end to facilitate pulling of the rip cord 128, when desired, by the user 10. In an example, the gripping member 138 includes a substantially spherical shape. However, in other examples, the gripping member can include other shapes, such as a ring, a straight handle, a T-shaped handle, an L-shaped handle, or the like. In an example, the rip cord 128 can be at least partially disposed within a sheath 126 of the garment 102 in order to maintain the rip cord 128 close to the garment 102 and/or in a particular location to facilitate the user 10 finding and pulling the rip cord 128 when the user 10 deems it desirable to deploy the speed limiting assembly 120. Having the rip cord 128 at least partially disposed within the sheath 126 also can limit lessen the chances of the rip cord 128 getting caught in something and accidentally pulled. In various examples, pulling of the rip cord 128 actuates the actuation mechanism 122 coupled with the gas canister 124, thereby moving the needle to pierce a seal on the gas canister 124, opening a valve, or otherwise control the actuation mechanism 122 to allow gas from within the gas canister 124 to flow into the deployable bladder 130.

In an example, the positioning of the enclosure 110 on the garment 102, the length that the speed limiting assembly 120 extends from the user 10, and/or drag from the chute 136 causes the user 10 to rotate while sliding down a slope, cliff, or the like, so a head of the user 10 points generally uphill. In another example, the drag from the chute 136 acts on the user 10 to turn the head of the user 10 around a center of gravity near a waist of the user 10. The head of the user 10 thereby points uphill and is turned away from downhill obstacles such as trees, rocks, ravines, cliffs and the like. In other examples, the deployment bladder 130 further acts to cause drag and facilitate a generally uphill positioning of the head of the user 10.

In an example, the deployment bladder 130, when inflated, is positioned at or around the head of the user 10 (as shown in FIG. 6) to provide at least some protection or cushioning from the ground, rocks, ice, trees, shrubs, or the like as the user slides down a slope. In an example, the deployment bladder 130, when inflated, extends out from the enclosure 110 in a generally uphill direction from the user 10, with the deployment bladder 130 disposed between the head of the user 10 and the surface of the slope.

Referring to FIG. 7, in another example, a speed limiting apparatus 200 is substantially similar to the speed limiting apparatus 100 described above. In this example, the speed limiting apparatus 200 includes a garment 202 configured to be worn by the user 10. The garment 202 can include, in various examples, a vest, a harness, a belt, a backpack, or the like. The garment 202, in an example, includes an enclosure 210 attached to the garment 202, the enclosure 210 being configured to at least partially house a speed limiting assembly 220. The speed limiting assembly 220, in an example, is substantially similar to the speed limiting assembly 120 described above in that it includes a chute 236, a deployable bladder 230, and an inflation mechanism. Although largely hidden from view within the enclosure 210 in FIG. 7, the inflation mechanism, in an example, is substantially similar to the inflation mechanism 121 described above. However, in an example, the speed limiting assembly 220 differs from the speed limiting assembly 120 in that the chute 236 is attached directly to the garment 202, rather than being coupled to the deployable bladder 230. In this example, the chute 236 is attached by cords 234 to the garment 202 in a position proximate the deployable bladder 230 so that inflation of the deployable bladder 230 assists in deployment of the chute 236 by forcing open the enclosure 210 and ejecting the chute 236. In an example, the chute 236 can be folded in a storage configuration and disposed between an opening of the enclosure 210 and the deployable bladder 230 (also in a folded, storage configuration), so that when the deployable bladder 230 is at least partially inflated, the deployable bladder 230 pushes the chute 236 out from within the enclosure 210 to help deploy the chute 236. In an example, the user 10 can selectively deploy the speed limiting assembly 220, in a manner similar to that described above with respect to the speed limiting assembly 120, by pulling a rip cord 238 attached to an activation mechanism. In an example, the rip cord 228 is at least partially disposed within a sheath 226 of the garment 202, for instance, to maintain the rip cord 228 in a particular location on the garment 202 and/or to limit the chances of the rip cord 228 being accidentally caught by an external object and/or inadvertently deployed. In a further example, the rip cord 228 can include a gripping member 238 to aid in grasping and pulling by the user 10.

Referring to FIGS. 1-7, in use, in an example, the garment 102, 202 of the speed limiting apparatus 100, 200 is worn by the user 10 and secured to the user 10 using the one or more fastening features 104 of the garment 102, 202. The user 10 can wear the speed limiting apparatus 100, 200 during activities in which speed reduction to control falling and/or sliding may be desirable, such as skiing, snowboarding, snowmobiling, climbing, hiking, or the like. The speed limiting apparatus 100, 200, in an example, is configured to be relatively lightweight and unobtrusive so as to enable the user 10 to perform whatever activity relatively unhampered by the speed limiting apparatus 100, 200.

If the user 10 deems it necessary to reduce speed (for instance, after falling and/or sliding down a slope on which the user 10 cannot sufficiently limit his speed through other means, such as dragging hands, feet, etc.), the user 10, in an example, can pull the rip cord 128, 228 to cause the speed limiting assembly 120, 220 to deploy. In an example, pulling of the rip cord 128 actuates the inflation mechanism 121 to at least partially inflate the deployment bladder 130. For instance, pulling the rip cord 128 can activate the actuation device 122 to fluidly couple the gas canister 124 with the deployment bladder 130, allowing gas from the gas canister 124 to flow into and at least partially inflate the deployment bladder 130. In an example, this inflation of the deployment bladder 130 increases the volume of the deployment bladder 130 sufficiently to open the enclosure 110 and push the chute 136 out of the enclosure 110. In this example, the chute 136 is separate from the deployment bladder 130 but is attached by the cords 134 and the connection strip 132 to a portion of the deployment bladder 130. The chute 136, in an example, is folded or otherwise configured to facilitate opening of the chute 136 as it is pushed out of the enclosure 110. Opening of the chute 136 is further aided by the air flowing past the moving user 10. In another example, pulling of the rip cord 228 actuates the inflation mechanism to at least partially inflate the deployment bladder 230. For instance, pulling the rip cord 228 can activate the actuation device to fluidly couple the gas canister with the deployment bladder 230, allowing gas from the gas canister to flow into and at least partially inflate the deployment bladder 230. In an example, this inflation of the deployment bladder 230 increases the volume of the deployment bladder 230 sufficiently to open the enclosure 210 and push the chute 236 out of the enclosure 210. In this example, the chute 236 is separate from the deployment bladder 230 and is attached by the cords 234 and the connection strip to a portion of the garment 202. The chute 236, in an example, is folded or otherwise configured to facilitate opening of the chute 236 as it is pushed out of the enclosure 210. Opening of the chute 236 is further aided by the air flowing past the moving user 10.

Once the chute 136, 236 is deployed, the chute 136, 236, in an example, trails the user 10 and catches the air. The chute 136, 236 increases the air resistance of the user 10 to act as an air brake in order to limit or otherwise reduce the speed of the user 10. In this way, deployment of the chute 136, 236, in an example, can slow the speed of the user 10 as the user 10 slides down a slope, for instance, after having fallen while skiing, snowboarding, snowmobiling, climbing, hiking, or the like. By slowing the speed of the user 10, the chute 136, 236 of the speed limiting assembly 120, 220 can decrease the likelihood of injury to the user 10 in the event of a mishap like falling or losing control on a slope of a mountain.

Once the user 10 has slowed sufficiently, in an example, the user 10 can await and/or seek rescue, seek shelter or safety, continue to proceed down the slope, or the like. In various examples, it can be desirable to collapse, remove, or otherwise stop the chute 136, 236 from creating added air resistance. For instance, keeping the chute 136, 236 deployed while trying to walk, climb, or otherwise move could result in the chute 136, 236 catching a gust of wind or other air flow and unsteadying the user 10, which could result in the user 10 further falling or sliding down the slope. In one example, the user 10 can bundle up the chute 136, 236 hold it or stash it in the garment 10 or otherwise on the user 10. In another example, the user 10 can remove the speed limiting apparatus 100, 200 by undoing the one or more fastening features 104 of the garment 102, 202 and taking off the garment 102, 202 and speed limiting assembly 110, 210. In still another example, the user 10 can detach the chute 136, 236, for instance, by using the pull cord to operate the quick release mechanism to detach the chute 136, as described above, or the like.

Loss of control and/or falling while downhill skiing, snowboarding, snowmobiling, or the like can result in injury or death to the person performing the activity. The present inventor has recognized that there exists an unmet need for a speed limiting device that can be used in the event that the skier, snowboarder, snowmobiler, etc. loses control and/or falls in order to selectively decrease, limit, retard, etc. the speed with which the individual is traveling and/or falling. The above described examples of speed limiting apparatuses are compact devices that fit comfortably and unobtrusively on a user. In one example, an enclosure including a chute, a deployment bladder, a gas canister, and an activation mechanism is positioned on a back of the user. The enclosure is thereby positioned in a location that does not interfere with the activity of the user (for instance, skiing, snowboarding, snowmobiling, climbing, hiking, and the like). Further, the speed limiting apparatus is sized and shaped to remain on the user during a variety of activities, such as, skiing, snowboarding, snowmobiling, climbing, hiking, and the like, thereby ensuring the speed limiting apparatus is properly positioned for use to limit the speed of the user during a fall or other period of uncontrolled movement. In yet another example, when deployed, the deployment bladder and the chute are positioned away from the center of gravity of the user. The drag from the chute rotates the user while sliding down a slope so that the head of the user is pointed uphill. Because the chute is coupled to the garment near the head of the user, the drag rotates the user around the center of gravity near the waist of the user. The head is thereby turned away and protected from oncoming downhill obstacles such as trees, rocks, ravines, cliffs and the like. Moreover, the deployment bladder, in some examples, when inflated, is configured to be positioned at or around the head of the user to provide at least some cushioning or protection of the head of the user. In an example, the deployment bladder is positioned between the head of the user and the surface of the slope.

It will be appreciated by those skilled in the art that changes could be made to the examples described above without departing from the broad inventive concept thereof. It is understood, therefore, that this invention is not limited to the particular examples disclosed, but it is intended to cover modifications within the spirit and scope of the present invention as defined by the present description.

The above Detailed Description includes references to the accompanying drawings, which form a part of the Detailed Description. The drawings show, by way of illustration, specific embodiments in which the invention can be practiced. These embodiments are also referred to herein as “examples.” All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more features thereof) may be used in combination with each other. Other embodiments can be used, such as by one of ordinary skill in the art upon reviewing the above description. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

The Abstract is provided to allow the reader to quickly ascertain the nature of the technical disclosure. It is submitted with the understanding that it will not be used to interpret or limit the scope or meaning of the claims.

1. A speed limiting apparatus comprising:
a garment configured to be worn by a user, the garment including an enclosure; and
a speed limiting assembly coupled to the garment, the speed limiting assembly including:
a chute disposed within the enclosure with the chute in a storage configuration, the chute being deployable from the storage configuration to a deployed configuration; and
a deployment bladder separate from the chute, the deployment bladder being positioned proximate the enclosure and the chute such that at least partial inflation of the deployment bladder opens the enclosure and deploys the chute.

2. The speed limiting apparatus of claim 1, wherein the deployment bladder is disposed at least partially within the enclosure.

3. The speed limiting apparatus of claims 1, wherein the chute is attached to the deployment bladder.

4. The speed limiting apparatus of claim 1, comprising an inflation mechanism configured to at least partially inflate the deployment bladder.

5. The speed limiting apparatus of claim 4, wherein the inflation mechanism includes a gas canister and an activation mechanism, the gas canister fluidly coupled to the deployment bladder and the activation mechanism coupled to the gas canister.

6. The speed limiting apparatus of claim 5, wherein the activation mechanism includes a rip cord.

7. The speed limiting apparatus of claim 1, wherein the chute includes a substantially circular shape.

8. The speed limiting apparatus of claim 1, wherein the garment includes a vest.

9. The speed limiting apparatus of claim 1, wherein the garment includes a harness.

10. The speed limiting apparatus of claim 1, wherein the garment includes a belt.

11. The speed limiting apparatus of claim 1, wherein the chute is configured to increase air resistance of the user when in the deployed configuration to limit the speed of the user.

12. The speed limiting apparatus of claim 1, wherein the chute is configured to selectively detach from the speed limiting apparatus.

13. A method of using a speed limiting assembly, the speed limiting assembly coupled to a garment configured to be worn by a user, the method comprising:
at least partially inflating a deployment bladder of the speed limiting assembly;
opening an enclosure of the garment; and
deploying a chute of the speed limiting assembly from a storage configuration within the enclosure to a deployed configuration, the chute configured to increase air resistance of the user when in the deployed configuration to limit the speed of the user, the chute being separate from the deployment bladder, wherein at least partially inflating the deployment bladder opens the enclosure and removes the chute from within the enclosure to deploy the chute.

14. The method of claim 13, wherein at least partially inflating the deployment bladder includes activating an actuation device.

15. The method of claim 14, wherein activating the actuation device fluidly couples a gas canister with the deployment bladder, allowing gas from the gas canister to flow into and at least partially inflate the deployment bladder.

16. The method of claim 15, wherein activating the actuation device includes pulling a rip cord.

17. The method of claim 13, comprising detaching the chute from the speed limiting assembly after deployment of the chute.

18. A speed limiting apparatus comprising:
a garment configured to be worn by a user, the garment including an enclosure; and
a speed limiting assembly coupled to the garment, the speed limiting assembly including:
an inflation mechanism;
a chute disposed within the enclosure with the chute in a storage configuration, the chute being deployable from the storage configuration to a deployed configuration; and
a deployment bladder coupled to and at least partially inflatable by the inflation mechanism, the deployment bladder disposed within the enclosure, the deployment bladder being separate from but attached to the chute, wherein at least partial inflation of the deployment bladder opens the enclosure and deploys the chute, wherein the chute, when in the deployed configuration, is configured to increase air resistance of the user to limit the speed of the user.

19. The speed limiting apparatus of claim 18, wherein the inflation mechanism includes a gas canister and an activation mechanism, the gas canister fluidly coupled to the deployment bladder and the activation mechanism coupled to the gas canister.

20. The speed limiting apparatus of claim 18, wherein the deployment bladder, when at least partially inflated, is positioned proximate a head of the user to provide at least some protection of the head of the user.
